(19) United States
(12) Patent Application Publication
(10) Pub. No.: US 2026/0195682 A1
(43) Pub. Date: Jul. 9, 2026

(54) SERVER AND METHOD FOR EVALUATING RISK FOR ACCOUNT OF USER FOR A PLURALITY OF TYPES OF ON-DEMAND SERVICES

(71) Applicant: GRABTAXI HOLDINGS PTE. LTD., Singapore (SG)

(72) Inventors: Muqi LI, Bellevue, WA (US); Jia CHEN, Singapore (SG); Anusha RAMAKRISHNAN, Singapore (SG); Zhou YU, Bellevue, WA (US); Xue Fang NG, Singapore (SG); Varun KANSAL, Bellevue, WA (US)

(21) Appl. No.: 18/868,881

(22) PCT Filed: May 4, 2023
(86) PCT No.: PCT/SG2023/050303

§ 371 Date: Nov. 25, 2024

(30) Foreign Application Priority Data
Jun. 2, 2022 (SG) 10202250008U

(51) Int. Cl. G06Q 10/0635; G06Q 20/40

(52) U.S. Cl. CPC G06Q 10/0635; G06Q 20/4016

(57) ABSTRACT

Aspects concern a server comprising: a memory configured to store a behaviour profile of a user for at least one of a plurality of types of on-demand services; and a processor configured to assign a user risk score to an account of the user, detect an occurrence of an event linked to the account of the user for any one of the plurality of types of on-demand services, adjust the user risk score assigned to the account of the user by adding or subtracting a predetermined score based on the event, and evaluate a risk for the account of the user for the plurality of types of on-demand services based on the adjusted user risk score, wherein the processor is configured to vary the predetermined score to be added or subtracted based on the event, based on a behaviour profile of the user.

### TECHNICAL FIELD

Various embodiments relate to a server and a method for evaluating a risk for an account of a user for a plurality of types of on-demand services.

### BACKGROUND

Due to development of information technology and users' growing expectations of immediacy, businesses have provided a wide range of on-demand services. The on-demand services may allow a user to fulfil the user's demand via an immediate access to goods and/or services. Due to growth in the on-demand services, the businesses have then provided a plurality of types of on-demand services (also referred to as “different business verticals”), such as a transport service, a food delivery service, a grocery delivery service, or a fintech service, via a single platform.

However, different business verticals may have their own database schema of gathering and processing information. For a protection of a specific business vertical using data obtained from other N business verticals, it may require N-times data processing. Ultimately, if the platform provides a total of N business verticals, it may require N×(N-1) data processing, to leverage data from each other business verticals for a cross-protection of the different business verticals. This may draw a challenge to a platform provider to monitor a potential fraud and a risk behaviour of the users as a whole across different types of the on-demand services, due to a data processing complicity and/or corresponding storage costs.

Therefore, there is a need to provide a solution for evaluating a risk for an account of a user for a plurality of types of on-demand services.

### SUMMARY

According to various embodiments, there is a server for evaluating a risk for an account of a user for a plurality of types of on-demand services. The server comprises: a memory configured to store a behaviour profile of the user for at least one of the plurality of types of on-demand services; and a processor configured to assign a user risk score to the account of the user, detect an occurrence of an event linked to the account of the user for any one of the plurality of types of on-demand services, adjust the user risk score assigned to the account of the user by adding or subtracting a predetermined score based on the event, and evaluate the risk for the account of the user for the plurality of types of on-demand services based on the adjusted user risk score, wherein the processor is configured to vary the predetermined score to be added or subtracted based on the event, based on the behaviour profile of the user.

In some embodiments, the processor is configured to determine if the adjusted user risk score is below a predetermined threshold, and trigger the user to perform a predetermined task to continue activating the account of the user for the plurality of types of on-demand services if the adjusted user risk score is below the predetermined threshold.

In some embodiments, the processor is configured to deactivate the account of the user for the plurality of types of on-demand services, if the predetermined task is not performed within a predetermined time.

In some embodiments, the processor is configured to adjust the user risk score assigned to the account of the user by adding the predetermined score corresponding to the task, if the predetermined task is performed within a predetermined time.

In some embodiments, the processor is configured to create an event score table indicating the predetermined score corresponding to each of a plurality of events.

In some embodiments, the processor is configured to update the predetermined score corresponding to each of the plurality of events of the event score table using machine learning.

In some embodiments, the processor is configured to receive a request for a transaction from the user, and decide whether to process the transaction and/or a priority for processing the transaction, based on the adjusted user risk score.

In some embodiments, the behaviour profile of the user includes a history of one or more events made by the user for the at least one of the plurality of types of on-demand services.

According to various embodiments, there is a method for evaluating a risk for an account of a user for a plurality of types of on-demand services, the method comprising: assigning a user risk score to the account of the user; detecting an occurrence of an event linked to the account of the user for any one of the plurality of types of on-demand services; adjusting the user risk score assigned to the account of the user by adding or subtracting a predetermined score based on the event; and evaluating the risk for the account of the user for the plurality of types of on-demand services based on the adjusted user risk score, wherein the predetermined score to be added or subtracted based on the event varies based on a behaviour profile of the user for at least one of the plurality of types of on-demand services.

In some embodiments, the method further comprises: determining if the adjusted user risk score is below a predetermined threshold; and if the adjusted user risk score is below the predetermined threshold, triggering the user to perform a predetermined task to continue activating the account of the user for the plurality of types of on-demand services.

In some embodiments, the method further comprises: if the predetermined task is not performed within a predetermined time, deactivating the account of the user for the plurality of types of on-demand services.

In some embodiments, the method further comprises: if the predetermined task is performed within a predetermined time, adjusting the user risk score assigned to the account of the user by adding the predetermined score corresponding to the task.

In some embodiments, the method further comprises: creating an event score table indicating the predetermined score corresponding to each of a plurality of events.

In some embodiments, the method further comprises: updating the predetermined score corresponding to each of the plurality of events of the event score table using machine learning.

In some embodiments, the method further comprises: receiving a request for a transaction from the user; and deciding whether to process the transaction and/or a priority for processing the transaction, based on the adjusted user risk score.

In some embodiments, the behaviour profile of the user includes a history of one or more events made by the user for the at least one of the plurality of types of on-demand services.

According to various embodiments, a data processing apparatus configured to perform the method of any one of the above embodiments is provided.

According to various embodiments, a computer program element comprising program instructions, which, when executed by one or more processors, cause the one or more processors to perform the method of any one of the above embodiments is provided.

According to various embodiments, a computer-readable medium comprising program instructions, which, when executed by one or more processors, cause the one or more processors to perform the method of any one of the above embodiments is provided. The computer-readable medium may include a non-transitory computer-readable medium.

### BRIEF DESCRIPTION OF THE DRAWINGS

The invention will be better understood with reference to the detailed description when considered in conjunction with the non-limiting examples and the accompanying drawings, in which:

FIG. 1 illustrates an infrastructure of a system including a server for evaluating a risk for an account of a user for a plurality of types of on-demand services according to various embodiments.

FIG. 2 illustrates a block diagram of a server for evaluating a risk for an account of a user for a plurality of types of on-demand services according to various embodiments.

FIG. 3 illustrates a flow diagram for a method for evaluating a risk for an account of a user for a plurality of types of on-demand services according to various embodiments.

FIG. 4 illustrates an exemplary event score table according to various embodiments.

FIG. 5 illustrates an exemplary flow diagram for a method for evaluating a risk for an account of a user for a plurality of types of on-demand services according to various embodiments.

FIG. 6 illustrates a block diagram of a server for evaluating a risk for an account of a user for a plurality of types of on-demand services according to various embodiments.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of a server and a method are analogously valid for the other server and method. Similarly, embodiments described in the context of a server are analogously valid for a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

Throughout the description, the term “module” may be understood as an application specific integrated circuit (ASIC), an electronic circuit, a combinational logic circuit, a field programmable gate array (FPGA), a processor which executes code, other suitable hardware components which provide the described functionality, or any combination thereof. The term of “module” may include a memory which stores code executed by the processor.

In the following, embodiments will be described in detail.

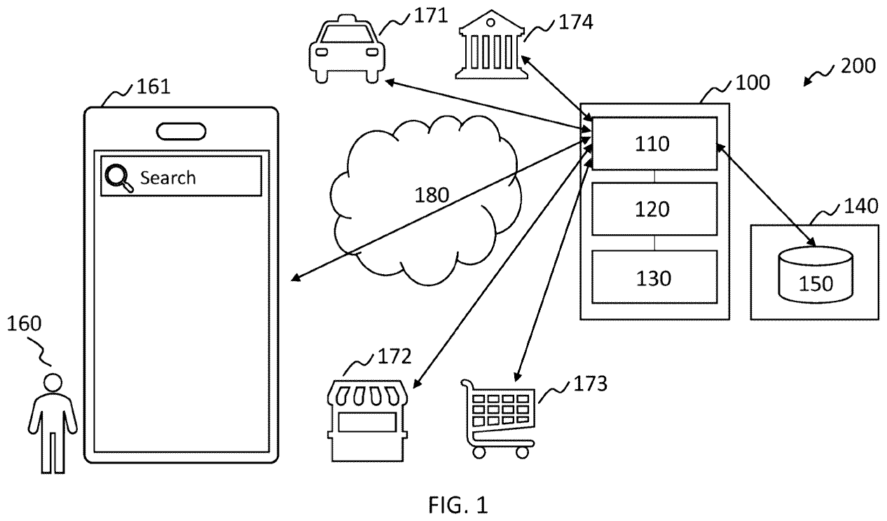

FIG. 1 illustrates an infrastructure of a system 200 including a server 100 for evaluating a risk for an account of a user 160 for a plurality of types of on-demand services according to various embodiments.

As shown in FIG. 1, the system 200 may include, but is not limited to, the server 100, a database system 140, a computing device 161, one or more external devices 171, 172, 173, 174, and a network 180.

In some embodiments, the on-demand service may be a service allowing the user 160 to fulfil the user's demand via an immediate access to goods and/or services. A platform provider may provide the plurality of types of on-demand services (also referred to as “different business verticals”), such as a transport service, a food delivery service, a grocery delivery service, or a fintech service, via a single platform operated by the server 100. The user 160 may use a single user account (also referred to as an “account of the user”) to enjoy the plurality of types of on-demand services via the single platform operated by the server 100.

In some embodiments, the network 180 may include, but is not limited to, a Local Area Network (LAN), a Wide Area Network (WAN), a Global Area Network (GAN), or any combination thereof. The network 180 may provide a wireline communication, a wireless communication, or a combination of the wireline and wireless communication between the server 100 and the computing device 161, and between the server 100 and the one or more external devices 171, 172, 173, 174.

In some embodiments, the computing device 161 may be connectable to the server 100 via the network 180. In some embodiments, the computing device 161 may be arranged in data or signal communication with the server 100 via the network 180. In some embodiments, the computing device 161 may include, but is not limited to, at least one of the following: a mobile phone, a tablet computer, a laptop computer, a desktop computer, a head-mounted display and a smart watch. In some embodiments, the computing device 161 may belong to the user 160. Although not shown, in some embodiments, the system 200 may further include a plurality of computing devices each belonging to a plurality of users. In some embodiments, the user 160 and the plurality of users may be customers who request the on-demand service, for example, the transport service.

In some embodiments, the computing device 161 may include a location sensor. In some embodiments, the location sensor may communicate with at least one of a global positioning satellite (GPS) server, a network server, and a Wi-Fi server, to detect a location of the computing device 161. In some embodiments, the computing device 161 may generate information about the location of the computing device 161.

In some embodiments, the computing device 161 may have installed thereon a software application (also referred to as a “user app”) which may allow the user 160 to make requests for on-demand services offered by service providers. In some embodiments, the user 160 may login with the account of the user, and request the on-demand services using a user interface provided by the software application. In some embodiments, the software application may allow payments for the on-demand services via the server 100 and/or via one or more payment processing servers (not shown).

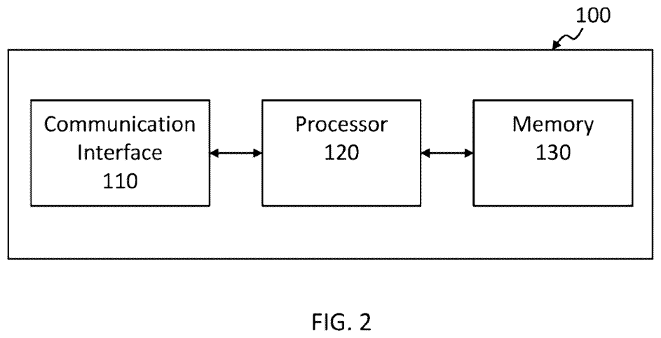

In some embodiments, the server 100, for example, implemented by a server computer, may include a communication interface 110, a processor 120, and a memory 130 (as will be described with reference to FIG. 2).

In some embodiments, the server 100 may communicate with the computing device 161 via the network 180. In some embodiments, the computing device 161 may receive a request from the user 160 for an on-demand service. The computing device 161 may send the request to the server 100 via the network 180. In some embodiments, the computing device 161 may send the information about the location of the computing device 161 to the server 100 via the network 180.

In some embodiments, the system 200 may further include a database 150. In some embodiments, the database 150 may be a part of the database system 140 which may be external to the server 100. The server 100 may communicate with the database 150. In some other embodiments, although not shown, the database 150 may be implemented locally in the memory 130 of the server 100.

In some embodiments, the one or more external devices 171, 172, 173, 174 belong to the service providers offering the on-demand services. For example, a first external device 171 may belong to a transport service provider to provide the transport service, a second external device 172 may belong to a food service provider to provide the food delivery service, a third external device 173 may belong to a market service provider to provide the grocery delivery service, and a fourth external device 174 may belong to a fintech service provider to provide the fintech service such as a payment service. It may be appreciated that the types of the on-demand services are not limited thereto. It may be appreciated that, for each type of the on-demand service, there may be a plurality of external devices each corresponding to a plurality of service providers.

In some embodiments, the server 100 may communicate with the one or more external devices 171, 172, 173, 174 via the network 180. The one or more external devices 171, 172, 173, 174 may have installed thereon a service provider application (also referred to as a “service provider app”) which allows the service provider thereof to receive, accept and fulfil requests for on-demand services from the computing device 161. The request for the on-demand service may be received at the server 100, and distributed to the one or more external devices 171, 172, 173, 174 according to various considerations, such as a type of services provided by the service providers, capacity of the service providers to fulfil the request, proximity to the user 160, etc.

In some embodiments, the server 100 may receive the request for the on-demand service with the information about the location of the computing device 161, and then determine which type of on-demand service the user 160 requests. For example, if the user 160 requests the transport service, the server 100 may communicate with the first external device 171 to provide the transport service to the user 160. As another example, if the user 160 requests the food delivery service, the server 100 may communicate with the second external device 172 to provide the food delivery service to the user 160.

FIG. 2 illustrates a block diagram of a server 100 evaluating a risk for an account of a user 160 for a plurality of types of on-demand services according to various embodiments.

As shown in FIG. 2, the server 100, for example, implemented by a server computer, may include a communication interface 110, a processor 120, and a memory 130.

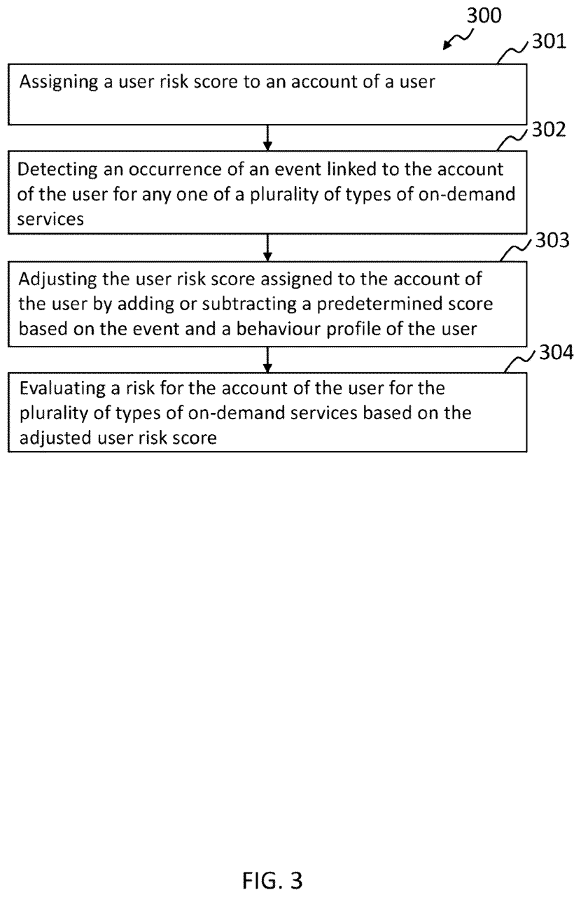

In some embodiments, the memory 130 (also referred to as a “database”) may store input data and/or output data temporarily or permanently. In some embodiments, the memory 130 may store program code which allows the server 100 to perform a method 300 (as will be described with reference to FIG. 3). In some embodiments, the program code may be embedded in a Software Development Kit (SDK). The memory 130 may include an internal memory of the server 100 and/or an external memory. The external memory may include, but is not limited to, an external storage medium, for example, a memory card, a flash drive, and a web storage.

In some embodiments, the memory 130 may store a behaviour profile of the user 160 for at least one of the plurality of types of on-demand services. In some embodiments, the behaviour profile of the user 160 may include a history of one or more events made by the user 160 for the at least one of the plurality of types of on-demand services. For example, the behaviour profile of the user 160 may include information on whether there was any overdue payment/no payment to one or more on-demand services previously provided to the user 160. In some other embodiments, the behaviour profile of the user 160 may be stored in a database 150, as shown in FIG. 1, and the processor 120 may fetch the behaviour profile of the user 160 from the database 150.

In some embodiments, the communication interface 110 may allow one or more computing devices, including a computing device 161, to communicate with the processor 120 of the server 100 via a network 180, as shown in FIG. 1. In some embodiments, as shown in FIG. 1, the computing device 161 may belong to the user 160 who wants to request the on-demand service. In some embodiments, the communication interface 110 may transmit signals to the computing device 161, and/or receive signals from the computing device 161 via the network 180.

In some embodiments, the communication interface 110 may allow one or more external devices 171, 172, 173, 174, for example, a transport service provider device 171, a food service provider device 172, a market service provider device 173, and a fintech service provider device 174, to communicate with the processor 120 of the server 100 via the network 180, as shown in FIG. 1. In some embodiments, the communication interface 110 may transmit signals to the one or more external devices 171, 172, 173, 174, and/or receive signals from the one or more external devices 171, 172, 173, 174, via the network 180.

In some embodiments, the communication interface 110 may receive the request for the on-demand service from the computing device 161 via the network 180. The communication interface 110 may then send the request for the on-demand service to the processor 120.

In some embodiments, the communication interface 110 may further receive information about a location of the computing device 161 from the computing device 161 via the network 180. The communication interface 110 may then send the information about the location of the computing device 161 to the processor 120.

The processor 120 may include, but is not limited to, a microprocessor, an analogue circuit, a digital circuit, a mixed-signal circuit, a logic circuit, an integrated circuit, a Central Processing Unit (CPU), a Graphics Processing Unit (GPU), a Digital Signal Processor (DSP), a Field Programmable Gate Array (FPGA), an Application Specific Integrated Circuit (ASIC), or any combination thereof. Any other kind of implementation of the respective functions, which will be described below in further detail, may also be understood as the processor 120.

In some embodiments, the processor 120 may be connectable to the communication interface 110. In some embodiments, the processor 120 may be arranged in data or signal communication with the communication interface 110 to receive the request for the on-demand service and the information about the location of the computing device 161.

In some embodiments, the processor 120 may assign a user risk score to the account of the user 160. In some embodiments, each user of a plurality of users may be initially given certain user risk scores. The user risk score may be added and subtracted based on each event (as will be described below).

In some embodiments, the user risk score of each user may represent a risk that each user poses to a platform provider and/or the service provider. Each user may have their own user risk score. For example, the user risk score of the user 160 may represent a chance that the user 160 will commit a fraud. As an example, the user risk score of the user 160 may represent a chance that the user 160 will not make a payment to an on-demand service provided by the service provider via a platform. For ease of explanations, throughout the description, the user 160 with a high user risk score means that the user 160 is less risky, and vice versa. Although not described herein, it may be appreciated that, in some other embodiments, the user 160 with a low user risk score means that the user 160 is less risky, and vice versa.

In some embodiments, the processor 120 may assign the same user risk score, for example, “100”, to each account of the plurality of users. Each user of the plurality of users may be given initial scores (also referred to as “starting scores”). In some other embodiments, the processor 120 may divide the plurality of users into two or more groups, and assign a different user risk score to each group. For example, the processor 120 may divide the plurality of users into two or more groups based on the behaviour profile, and assign the high user risk score to a group with a good behaviour profile and the low user risk score to a group with a bad behaviour profile. As an example, the processor 120 may convert each user's behaviour profile into a value or a grade for grouping.

In some embodiments, the processor 120 may detect an occurrence of an event linked to the account of the user 160 for any one of the plurality of types of on-demand services. In some embodiments, the processor 120 may detect a category of the event, and detect the event under the category of the event. In some embodiments, the category of the event may include, but is not limited to, a login to the software application with the account of the user 160, a payment to an on-demand service, a request for the on-demand service (booking), and a completion of the receipt of the on-demand service. In some embodiments, the events under the category of the login to the software application may include, but are not limited to, detecting a risky IP (Internet Protocol) address (for example, the IP address owned by a data centre which indicates a risk of a device farm), and detecting that the computing device 161 is shared with other user(s). In some embodiments, the events under the category of the payment may include, but are not limited to, a successful authentication of the user 160, a failed authentication of the user 160, and detecting that a credit card registered by the user 160 is shared with other user(s). In some embodiments, the event under the category of the booking may include, but is not limited to, detecting that the same driver was previously allocated to the user 160.

In some embodiments, the processor 120 may adjust the user risk score assigned to the account of the user 160 by adding or subtracting a predetermined score based on the event. For example, if the user 160 logs in to the software application and the processor 120 detects that the user's 160 IP address is the risky IP address, the processor 120 may subtract the predetermined score, for example, “2”, from the user risk score, for example, “100”. As another example, if the user 160 makes the request for the transport service and the processor 120 detects that the user 160 previously attempted too frequent bookings which were then cancelled before a driver is allocated to the user 160, the processor 120 may subtract the predetermined score, for example, “20” from the adjusted user risk score, for example, “98” (which was calculated by subtracting “2” from “100”). As another example, if the user 160 succeeds the authentication of the user 160, the processor 120 may add the predetermined score, for example, “15” to the adjusted user risk score, for example, “78” (which was calculated by subtracting “20” from “98”).

In some embodiments, the processor 120 may vary the predetermined score to be added or subtracted based on the event, based on the behaviour profile of the user. In some embodiments, the predetermined score to be added or subtracted may vary between users even for the same type of event, based on their behaviour profiles. For example, if the user 160 previously made a number of successful transactions with the account of the user 160, the processor 120 may consider the user 160 as a less risky user, and the predetermined score to be added may be higher than a default predetermined score to be added and the predetermined score to be subtracted may be lower than a default predetermined score to be subtracted. As another example, if the user 160 previously attempted too frequent bookings which were then cancelled before a driver is allocated to the user 160, the processor 120 may consider the user 160 as a high risky user, and the predetermined score to be added may be lower than a default predetermined score to be added and the predetermined score to be subtracted may be higher than a default predetermined score to be subtracted.

In some other embodiments, the predetermined score to be added or subtracted may vary between users even for the same type of event, based on their behaviour profiles and other external circumstances. In some embodiments, the other external circumstances may be changes of attribution that links to them. For example, if the processor 120 detects that the IP address commonly used by the user 160 is now abused by a fraudster, the user risk score of the user 160 may also be impacted.

In some embodiments, the behaviour profiles of the users may include a history of one or more events made by each user for the at least one of the plurality of types of on-demand services. For example, if the user 160 requests the transport service, the processor 120 may consider the history of one or more events for a food delivery service and a market delivery service made by the user 160.

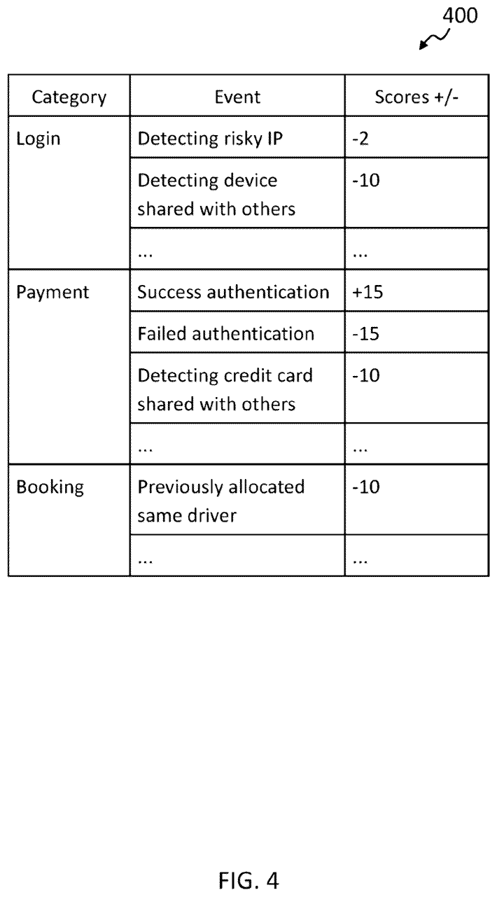

In some embodiments, the processor 120 may create an event score table indicating the predetermined score corresponding to each of a plurality of events (as will be described with FIG. 4). In some embodiments, the event score table may be generated, when the user 160 signs up for the software application. In some embodiments, the event score table which is generated may include the default predetermined score corresponding to each of the plurality of events.

In some embodiments, the processor 120 may update the predetermined score corresponding to each of the plurality of events of the event score table using machine learning. In some embodiments, the predetermined score to be added or subtracted may be calculated by a machine learning model. In some embodiments, the processor 120 may receive input data relating to a plurality of variables. In some embodiments, the processor 120 may input the input data to the machine learning model. In some embodiments, the machine learning model may be trained to output an event metric based on values of the plurality of variables. In some embodiments, the processor 120 may update the predetermined score corresponding to each of the plurality of events, based on the event metric. In some embodiments, the input data of the machine learning model may be a list which keeps changing, but the prominent ones may be the same features used for score calculation. With longer history events, a sequence of score change events of a user, or user's reactions to a prediction may also be used as label data for the machine learning model training. The machine learning score may be used as a supplementary information to improve a prediction performance (for example, not blocking users if the difference between the machine learning score and the predetermined score is huge (e.g. above a predetermined value)).

In some embodiments, the processor 120 may evaluate the risk for the account of the user 160 for the plurality of types of on-demand services based on the adjusted user risk score. In some embodiments, the processor 120 may evaluate the risk for the user 160 for the plurality of types of on-demand services including, not limited to, the transport service, the food delivery service, the grocery delivery service, or the fintech service, provided by the platform provider via the single platform operated by the server 100.

In some embodiments, the processor 120 may determine if the adjusted user risk score is below a predetermined threshold. In some embodiments, the processor 120 may then trigger the user 160 to perform a predetermined task to continue activating the account of the user 160 for the plurality of types of on-demand services if the adjusted user risk score is below the predetermined threshold. In some embodiments, when the adjusted user risk score is below the predetermined threshold, the predetermined task, for example, a corresponding verification/action, may be triggered to mitigate the risk for the user 160. For example, if the adjusted user risk score is below “60”, the processor 120 may trigger the user 160 to log in to the software application again.

In some embodiments, the processor 120 may set a plurality of predetermined thresholds, for example, a first predetermined threshold and a second predetermined threshold, and trigger the user 160 to perform a different task based on the adjusted user risk score. In some embodiments, multiple tiers of the predetermined thresholds may be set up, so that the processor 120 can trigger the user 160 to perform different tasks for a further verification or a risk mitigation. For example, if the adjusted user risk score is below “60”, the processor 120 may trigger the user 160 to log in to the software application again. As another example, if the adjusted user risk score is below “55”, the processor 120 may trigger the user 160 to perform a multi-factor authentication, for example, a two-factor authentication.

In some embodiments, if the user 160 successfully performs the predetermined task, the processor 120 may continue activating the account of the user 160 for the plurality of types of on-demand services. In some embodiments, the processor 120 may adjust the user risk score assigned to the account of the user 160 by adding a predetermined score corresponding to the task, if the predetermined task is performed. For example, if the user 160 successfully performs the predetermined task within the predetermined time, the processor 120 may add the predetermined score to the user risk score. As an example, if the user 160 correctly respond to a request for an authentication, the processor 120 may add the predetermined score corresponding to an event of the authentication, for example, “15”, to the user risk score. In some other embodiments, the processor 120 may continue activating the account of the user 160 for the plurality of types of on-demand services and/or add the predetermined score to the user risk score, if the user 160 successfully performs the predetermined task within a predetermined time.

In some other embodiments, if the user 160 resolves a negative impact, for example, paying off an unpaid balance for an on-demand service, the processor 120 may add a predetermined score corresponding to an event of paying off to the user risk score.

In some other embodiments, upon a successful transaction, the processor 120 may add a predetermined score corresponding to an event of the successful transaction to the user risk score.

In some embodiments, the processor 120 may deactivate the account of the user 160 for the plurality of types of on-demand services, if the predetermined task is not performed within the predetermined time. In some embodiments, if the user fails to perform the predetermined task or does not try to perform the predetermined task, the processor 120 may deactivate the account of the user 160 for the plurality of types of on-demand services including, not limited to, the transport service, the food delivery service, the grocery delivery service, or the fintech service, provided by the platform provider via the single platform operated by the server 100.

In some other embodiments, if the predetermined task is not performed within the predetermined time, the processor 120 may deactivate the account of the user 160 for at least one of the plurality of types of on-demand services, for example, based on the adjusted user risk score. For example, if the adjusted user risk score is below a third predetermined threshold, the processor 120 may deactivate the account of the user 160 for the fintech service but still continue activating the account of the user 160 for the other types of on-demand services. As another example, if the adjusted user risk score is below a fourth predetermined threshold which is below the third predetermined threshold, the processor 120 may deactivate the account of the user 160 for the fintech service, the food delivery service, and the grocery delivery service, but still continue activating the account of the user 160 for the transport service. In some embodiments, the processor 120 may require the user 160 to perform an authentication of the user 160 to re-activate the account of the user 160 for the plurality of types of on-demand services.

In some embodiments, the processor 120 may receive a request for a transaction from the user 160, and decide whether to process the transaction and/or a priority for processing the transaction, based on the adjusted user risk score. In some embodiments, if the processor 120 receives the request for the transaction from the user 160, the processor 120 may check the user risk score, and decide whether to process the transaction, based on the adjusted user risk score. For example, if the user 160 requests a redemption of a reward for a payment to an on-demand service and the user risk score is below a fifth predetermined threshold, for example, “50”, the processor 120 may decline the redemption of the reward. In some other embodiments, if the processor 120 receives the request for the transaction from the user 160, the processor 120 may check the user risk score, and decide the priority for processing the transaction, based on the adjusted user risk score. For example, if the user 160 requests the food delivery service and the user risk score is below a six predetermined threshold, for example, “40”, the processor 120 may give a low priority to an allocation of the food delivery service requested by the user 160.

As described above, conventionally, for fraud risks posed by different business verticals, data silos are created by default and thus it may not be able to unify all data captured together to produce a global risk indicator for the user 160. The server 100 according to various embodiments may continuously track and evaluate user activities and transactions as a whole throughout his/her day-to-day user journey at the single platform, instead of processing user activities and transactions from one business vertical and transforming data to be used by another business vertical for a risk evaluation.

FIG. 3 illustrates a flow diagram for a method 300 for evaluating a risk for an account of a user for a plurality of types of on-demand services according to various embodiments. According to various embodiments, the method 300 for evaluating the risk for the account of the user for the plurality of types of on-demand services may be provided.

In some embodiments, the method 300 may include a step 301 of assigning a user risk score to the account of the user.

In some embodiments, the method 300 may include a step 302 of detecting an occurrence of an event linked to the account of the user for any one of the plurality of types of on-demand services.

In some embodiments, the method 300 may include a step 303 of adjusting the user risk score assigned to the account of the user by adding or subtracting a predetermined score based on the event.

In some embodiments, the method 300 may include a step 304 of evaluating the risk for the account of the user for the plurality of types of on-demand services based on the adjusted user risk score.

In some embodiments, in the step 303, the predetermined score to be added or subtracted based on the event varies based on a behaviour profile of the user for at least one of the plurality of types of on-demand services.

FIG. 4 illustrates an exemplary event score table 400 according to various embodiments.

As shown in FIG. 4, the event score table may indicate a predetermined score corresponding to each of a plurality of events under a corresponding category of the event. In some embodiments, the category of the event may include, but is not limited to, a login to the software application with an account of a user 160, a payment to an on-demand service, and a request for the on-demand service (booking).

In some embodiments, the events under the category of the login to the software application may include, but are not limited to, detecting a risky IP (Internet Protocol) address (for example, the IP address owned by a data centre which indicates a risk of a device farm), and detecting that a computing device 161 is shared with other user(s). For example, “2” may be allocated as the predetermined score to be subtracted for the event of a detection of the risky IP address. As another example, “10” may be allocated as the predetermined score to be subtracted for the event of a detection of the computing device 161 that is shared with other user(s).

In some embodiments, the events under the category of the payment may include, but are not limited to, a successful authentication of the user 160, a failed authentication of the user 160, and detecting that a credit card registered by the user 160 is shared with other user(s). For example, “15” may be allocated as the predetermined score to be added for the event of the successful authentication, “15” may be allocated as the predetermined score to be subtracted for the event of the failed authentication. As another example, “10” may be allocated as the predetermined score to be subtracted for the event of a detection of the user's 160 credit card that is shared with other user(s).

In some embodiments, the event under the category of the booking may include, but is not limited to, detecting that the same driver was previously allocated to the user 160. For example, “10” may be allocated as the predetermined score to be subtracted for the event of a detection of an allocation of the same driver.

Although not shown, in some embodiments, the category of the event and the plurality of events may be updated. In some embodiments, the predetermined score corresponding to each of the plurality of events of the event score table 400 may be updated using machine learning (as described with reference to FIG. 2).

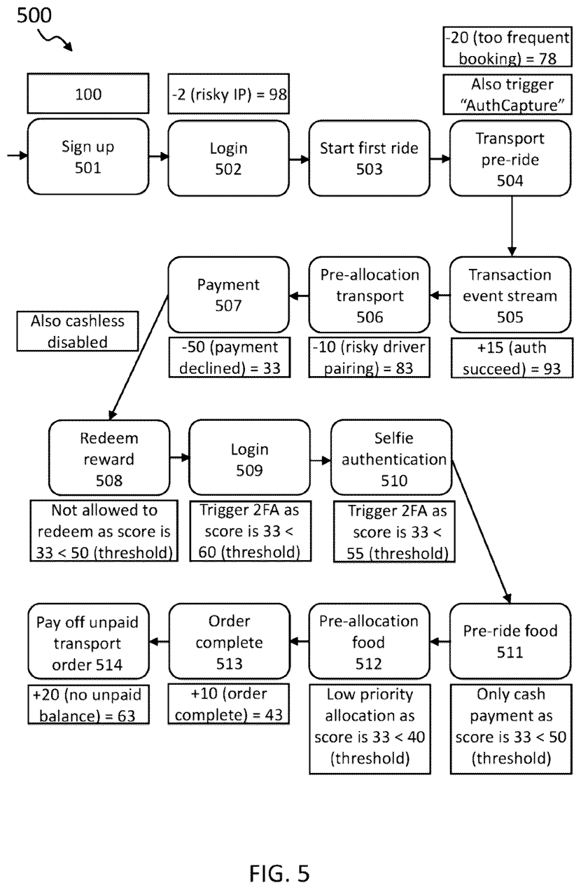

FIG. 5 illustrates an exemplary flow diagram for a method 500 for evaluating a risk for an account of a user 160 for a plurality of types of on-demand services according to various embodiments.

In some embodiments, the exemplary method 500 may include a step 501 of which the user 160 signs up for a software application. In the step 501, a user risk score “100” may be assigned to the user 160.

In some embodiments, the exemplary method 500 may include a step 502 of which the user 160 logs in to the software application. In the step 502, if it is detected that the user's IP address is a risky IP address (for example, the IP address owned by a data centre which indicates a risk of a device farm), a predetermined score “2” may be subtracted from the user risk score “100”, and the user risk score may be adjusted to “98”.

In some embodiments, the exemplary method 500 may include a step 503 of which the user 160 starts a first ride by a request for a transport service.

In some embodiments, the exemplary method 500 may include a step 504 of which it is detected that the user 160 previously attempted too frequent bookings which were then cancelled before a driver is allocated to the user 160. In the step 504, a predetermined score “20” may be subtracted from the adjusted user risk score “98”, and the user risk score may be adjusted to “78”. In addition, in the step 504, a predetermined task, for example, an authentication, may be requested to the user 160. In some embodiments, the request for the authentication may include a request for an authorisation and a capture (also referred to as an “AuthCapture”). In some embodiments, the request for the authorisation and the capture may include a request for authorising the user's 160 payment method, for example, a credit card, to ensure that it is valid and/or that sufficient funds are available.

In some embodiments, the exemplary method 500 may include a step 505 of which the user 160 may perform the authentication, for example, a transaction event. In the step 505, if the user 160 successfully performs the authentication, a predetermined score “15” may be added to the adjusted user risk score “78”, and the user risk score may be adjusted to “93”.

In some embodiments, the exemplary method 500 may include a step 506 of detecting that the same driver was previously allocated to the user 160. In the step 506, a predetermined score “10” may be subtracted from the adjusted user risk score “93”, and the user risk score may be adjusted to “83”.

In some embodiments, the exemplary method 500 may include a step 507 of which the user 160 tries to pay for the transport service. In the step 507, if the payment is declined, a predetermined score “50” may be subtracted from the adjusted user risk score “83”, and the user risk score may be adjusted to “33”.

In some embodiments, the exemplary method 500 may include a step 508 of which the user 160 tries to pay for the transport service by a redemption of a reward after a failure of cashless payment. In the step 508, a request for the redemption of the reward may be declined as the adjusted user risk score is “33” which is below a predetermined threshold “50”.

In some embodiments, the exemplary method 500 may include a step 509 of which the user 160 logs in to the software application. In the step 509, as the adjusted user risk score “33” is below a predetermined threshold “60”, a predetermined task, for example, a multi-factor authentication, may be requested to the user 160. As an example, the multi-factor authentication may include a two-step authentication.

In some embodiments, the exemplary method 500 may include a step 510 of which the user 160 performs a selfie authentication by taking the selfie of the user 160. In the step 510, as the adjusted user risk score “33” is below a predetermined threshold “55”, a predetermined task, for example, a multi-factor authentication, may be requested to the user 160. As an example, the multi-factor authentication may include a two-step authentication.

In some embodiments, the exemplary method 500 may include a step 511 of which the user 160 requests a pre-ride food service. In some embodiments, the pre-ride food service may include a check after the user 160 places a food delivery order but before a driver to pick up the order is allocated. In the step 511, as the adjusted user risk score “33” is below a predetermined threshold “50”, a predetermined transaction method, for example, only a cash payment to the food delivery order, may be available to the user 160.

In some embodiments, the exemplary method 500 may include a step 512 of which the user 160 requests a pre-allocation food service. In some embodiments, the pre-allocation food service may include a check performed when the processor 120 of the system 100 tries to assign the order to a driver candidate. In the step 512, as the adjusted user risk score “33” is below a predetermined threshold “40”, a low priority for the allocation of the food delivery order may be given to the user 160.

In some embodiments, the exemplary method 500 may include a step 513 of completing a receipt of the on-demand service (e.g. the food delivery order). In the step 513, a predetermined score “10” may be added to the adjusted user risk score “33”, and the user risk score may be adjusted to “43”.

In some embodiments, the exemplary method 500 may include a step 514 of which the user 160 pays off a balance for the unpaid transport service. In the step 514, a predetermined score “20” may be added to the adjusted user risk score “43”, and the user risk score may be adjusted to “63”.

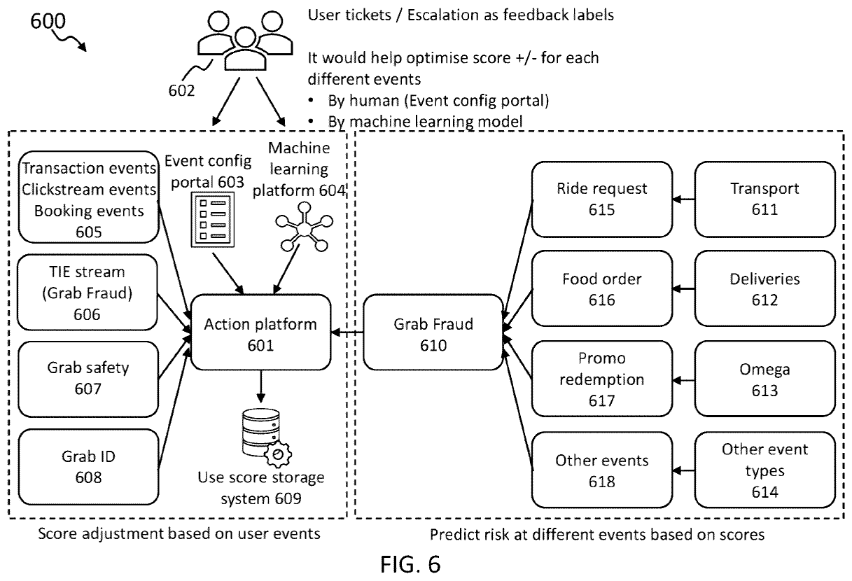

FIG. 6 illustrates a block diagram of a server 600 for evaluating a risk for an account of a user for a plurality of types of on-demand services according to various embodiments.

In some embodiments, the server 600 may receive users'602 tickets and/or escalations as feedback labels. The users'602 tickets and/or escalations may be used to optimise a predetermined score for each different events of an event score table. In some embodiments, the event score table may be optimised by a person, for example, a person from a platform provider, via an event configuration portal 603, and/or by a machine learning model 604 (as described with reference to FIG. 2).

In some embodiments, an action platform 601 may receive input data from a plurality of events 605 including, not limited to, transaction events, clickstream events, and booking events, an event streaming module containing event data from different business verticals (for example, a TIE stream module 606), a safety module 607, and accounts 608, for example, IDs, of the users 602. In some embodiments, as described above, the action platform 601 may receive input data from the event configuration portal 603 and the machine learning model 604. In some embodiments, the action platform 601 may receive input data from a fraud module 610. In some embodiments, the action platform 601 may optimise the predetermined score for each different events of the event score table, and transmit the optimised score to a user score storage system 609. In this manner, the predetermined score may be updated/adjusted at least based on user events. In some embodiments, the action platform 601 may receive different events from an external stream to update the predetermined score in real-time. For example, the external stream may include a Kafka stream which is a client library for building applications where input data and output data are stored in a Kafka cluster.

According to a conventional technology, different business verticals 611, 612, 613, 614 may have a user risk score for each corresponding business verticals, for example, obtained from each corresponding event 615, 616, 617, 618. In some embodiments, the fraud module 610 may fetch each user risk score in real-time as an additional source for a holistic risk evaluation for the user. In some embodiments, the fraud module 610 may provide each user risk score provided from the different business verticals 611, 612, 613, 614 to the action platform 601. This may improve a prediction resilience when dependent services (which provides data for the risk evaluation) are unable to return the data on time.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A server for evaluating a risk for an account of a user for a plurality of types of on-demand services, the server comprising:
a memory configured to store a behaviour profile of the user for at least one of the plurality of types of on-demand services; and
a processor configured to assign a user risk score to the account of the user, detect an occurrence of an event linked to the account of the user for any one of the plurality of types of on-demand services, adjust the user risk score assigned to the account of the user by adding or subtracting a predetermined score based on the event, and evaluate the risk for the account of the user for the plurality of types of on-demand services based on the adjusted user risk score, wherein the processor is configured to vary the predetermined score to be added or subtracted based on the event, based on the behaviour profile of the user.

2. The server according to claim 1, wherein the processor is configured to determine if the adjusted user risk score is below a predetermined threshold, and trigger the user to perform a predetermined task to continue activating the account of the user for the plurality of types of on-demand services if the adjusted user risk score is below the predetermined threshold.

3. The server according to claim 2, wherein the processor is configured to deactivate the account of the user for the plurality of types of on-demand services, if the predetermined task is not performed within a predetermined time.

4. The server according to claim 2, wherein the processor is configured to adjust the user risk score assigned to the account of the user by adding the predetermined score corresponding to the task, if the predetermined task is performed within a predetermined time.

5. The server according to claim 1, wherein the processor is configured to create an event score table indicating the predetermined score corresponding to each of a plurality of events.

6. The server according to claim 5, wherein the processor is configured to update the predetermined score corresponding to each of the plurality of events of the event score table using machine learning.

7. The server according to claim 1, wherein the processor is configured to receive a request for a transaction from the user, and decide whether to process the transaction and/or a priority for processing the transaction, based on the adjusted user risk score

8. The server according to claim 1, wherein the behaviour profile of the user includes a history of one or more events made by the user for the at least one of the plurality of types of on-demand services.

9. A method for evaluating a risk for an account of a user for a plurality of types of on-demand services, the method comprising:
assigning a user risk score to the account of the user;
detecting an occurrence of an event linked to the account of the user for any one of the plurality of types of on-demand services;
adjusting the user risk score assigned to the account of the user by adding or subtracting a predetermined score based on the event; and
evaluating the risk for the account of the user for the plurality of types of on-demand services based on the adjusted user risk score,
wherein the predetermined score to be added or subtracted based on the event varies based on a behaviour profile of the user for at least one of the plurality of types of on-demand services.

10. The method according to claim 9 further comprising:
determining if the adjusted user risk score is below a predetermined threshold; and if the adjusted user risk score is below the predetermined threshold, triggering the user to perform a predetermined task to continue activating the account of the user for the plurality of types of on-demand services.

11. The method according to claim 10 further comprising: if the predetermined task is not performed within a predetermined time, deactivating the account of the user for the plurality of types of on-demand services.

12. The method according to claim 10 further comprising: if the predetermined task is performed within a predetermined time, adjusting the user risk score assigned to the account of the user by adding the predetermined score corresponding to the task.

13. The method according to claim 9 further comprising: creating an event score table indicating the predetermined score corresponding to each of a plurality of events.

14. The method according to claim 13 further comprising: updating the predetermined score corresponding to each of the plurality of events of the event score table using machine learning.

15. The method according to claim 9 further comprising:
receiving a request for a transaction from the user; and
deciding whether to process the transaction and/or a priority for processing the transaction, based on the adjusted user risk score.

16. The method according to claim 9, wherein the behaviour profile of the user includes a history of one or more events made by the user for the at least one of the plurality of types of on-demand services.

17. A data processing apparatus configured to perform the method of claim 9.

18. A computer-readable medium comprising program instructions, which, when executed by one or more processors, cause the one or more processors to perform the method of claim 9.
